(19) United States
(12) Patent Application Publication
(10) Pub. No.: US 2015/0178163 A1
(43) Pub. Date: Jun. 25, 2015

(54) SYSTEM AND METHOD FOR TRANSMITTING FILES

(71) Applicant: Industrial Technology Research Institute, Hsinchu (TW)

(72) Inventors: Shih-Ying CHANG, Nantou County (TW); Hsin-Ta CHIAO, Nantou County (TW); Yi-Ting KUO, Hsinchu City (TW); Ming-Jing LI, Hualien County (TW); Xin-Yan YEH, New Taipei City (TW)

(21) Appl. No.: 14/326,417

(22) Filed: Jul. 8, 2014

(30) Foreign Application Priority Data
Dec. 24, 2013 (TW) 102147886

(51) Int. Cl. G06F 11/14; G06F 17/30; H04L 29/08

(52) U.S. Cl. CPC G06F 11/1412; H04L 67/06; G06F 17/30082

(57) ABSTRACT

A system and method for transmitting files are provided. The system for transmitting files, which is applied for transmitting data in a multiple-session transmission, wherein the data includes a plurality of split files and in the multiple-session transmission, every split file is regarded as a transmission unit. The system includes a transmitting device transmits the split files and when a repair-file mechanism is triggered, generate a repair file. The system further includes a receiving device receives the repair file and generate the split files which have not been received according to the repair file.

### CROSS REFERENCE TO RELATED APPLICATIONS

This application claims priority of Taiwan Patent Application No. 102147886, filed on Dec. 24, 2013, the entireties of which are incorporated by reference herein.

### BACKGROUND

1. Technical Field

The disclosure is related to a system and method for transmitting files, and also related to accelerate data transmission by a repair file in the multiple-session transmission.

2. Description of the Related Art

Wireless communication systems have been widely deployed to provide various telecommunication services such as telephony, video, data, messaging, and broadcast services. Typical wireless communication systems may employ multiple-access technologies capable of supporting communications with multiple users by sharing available system resources (e.g., bandwidth and radio frequency). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

Multiple-session transmission is meant that data is transmitted by different sessions, such as multiple connections, multiple paths, multiple networks and so on. In multiple connections, every session uses the same IP, and uses different ports for distinguishing different sessions. In multiple paths, every session uses a different IP. In multiple Networks, every session uses a different network (e.g. Ethernet or Wi-Fi). The advantages of multiple-session transmission include that the throughput is increased as a result of the increased bandwidth, and the tolerance of some transmission-path error or instability is increased.

However, when data is transmitted by the multiple-session transmission, the reception of files may be delayed. For a streaming service which needs to be displayed in order, the effective buffer level of the receiving end may be affected. In multiple-session transmission, the transmission quality of every session may be affected by factors such as network-state instability, and the supported network bandwidth being different (e.g. bandwidth of the cable network is usually faster than bandwidth of the wireless network). In addition, when there are more concurrent sessions, the network transmission variation may be larger and the received order of files may be varied seriously. How to maintain the desirable throughput and the viewing quality at the same time may be an important subject.

### BRIEF SUMMARY

Systems and methods of transmitting files are provided in the disclosure for accelerating data transmissions by a repair file in the multiple-session transmission.

An embodiment of the disclosure provides a system for transmitting files, which is applied for transmitting data in a multiple-session transmission, wherein the data includes a plurality of split files and in the multiple-session transmission, every split file is regarded as a transmission unit. The system includes a transmitting device and a receiving device. The transmitting device transmits the split files and when a repair-file mechanism is triggered and generates a repair file. The receiving device receives the repair file and generates the split files which have not been received according to the repair file.

An embodiment of the disclosure provides a transmitting device, which is applied for transmitting data in a multiple-session transmission, wherein the data includes a plurality of split files and in the multiple-session transmission, every split file is regarded as a transmission unit. The transmitting device includes a plurality of senders, an encoder and a first controller. The senders transmit the split files and a repair file to a receiving device. The first controller generates the repair file according to the split files which have not been received by the receiving device when a repair-file mechanism is triggered.

An embodiment of the disclosure provides a receiving device, which is applied for receiving data in a multiple-session transmission, wherein the data includes a plurality of split files and in the multiple-session transmission, every split file is regarded as a transmission unit. The receiving device includes a plurality of receivers, a decoder, and a second controller. The receivers receive at least one of the split files and repair file from a transmitting device. The second controller generates the split files which have not been received according to the repair file when a repair-file mechanism is triggered.

An embodiment of the disclosure provides a method for transmitting files, which is applied for transmitting data in a multiple-session transmission, wherein the data includes a plurality of split files and in the multiple-session transmission, every split file is regarded as a transmission unit. The method includes steps of transmitting the split files by a transmitting device; generating a repair file when a repair-file mechanism is triggered; receiving the repair file by a receiving device; and generating the split files which have not been received according to the repair file.

An embodiment of the disclosure provides a method for transmitting files, which is applied for transmitting data in a multiple-session transmission by a transmitting device, wherein the data includes a plurality of split files and in the multiple-session transmission, every split file is regarded as a transmission unit. The method includes steps of transmitting the split files to a receiving device; generating a repair file according to the split files which have not been received by the receiving device when a repair-file mechanism is triggered; and transmitting the repair file to the receiving device.

An embodiment of the disclosure provides a method for transmitting files, which is applied for receiving data in a multiple-session transmission by a receiving device, wherein the data includes a plurality of split files and in the multiple-session transmission, every split file is regarded as a transmission unit. The method includes steps of receiving at least one of the split files and repair file from a transmitting device; receiving a repair file when a repair-file mechanism is triggered; and generating the split files which have not been received according to the repair file.

### BRIEF DESCRIPTION OF THE DRAWINGS

The disclosure will become more fully understood by referring to the following detailed description with reference to the accompanying drawings, wherein:

FIG. 1 is a schematic diagram illustrating the file transmission system 100 according to an embodiment of the disclosure;

FIG. 2 is a schematic diagram illustrating the source block according to an embodiment of the disclosure;

FIG. 3A is a schematic diagram illustrating the first controller 112 according to an embodiment of the disclosure;

FIG. 3B is a schematic diagram illustrating the second controller 122 according to the embodiment of the disclosure;

FIG. 4A is a schematic diagram illustrating the first controller 112 according to another embodiment of the disclosure;

FIG. 4B is a schematic diagram illustrating the second controller 122 according to the embodiment of the disclosure;

FIG. 5 is a flowchart of a method for transmitting files according to an embodiment of the disclosure;

FIG. 6 is a flowchart of a method for transmitting files according to another embodiment of the disclosure;

FIG. 7 is a flowchart of a method for transmitting files according to another embodiment of the disclosure.

### DETAILED DESCRIPTION

This description is made for the purpose of illustrating the general principles of the invention and should not be taken in a limiting sense. The scope of the invention is best determined by reference to the appended claims.

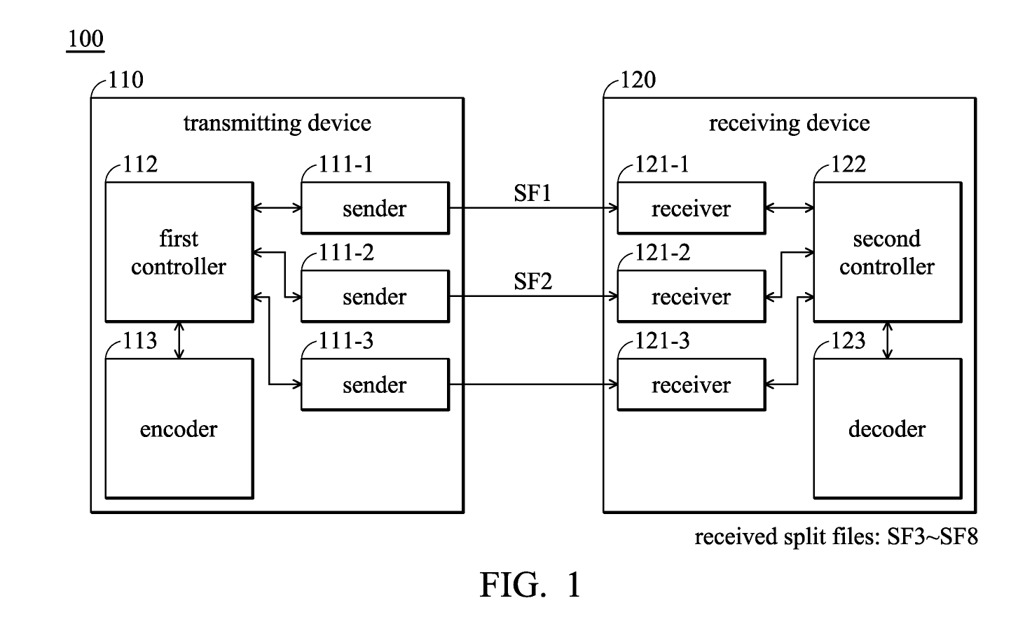

FIG. 1 is a schematic diagram illustrating the file transmission system 100 according to an embodiment of the disclosure. In an embodiment of the disclosure, the file transmission system 100 may be applied for transmitting data in a multiple-session transmission, wherein the multiple-session transmission may be multiple path transmission, multiple network transmission, Multi-input Multi-output (MIMO) transmission and so on. When the multiple-session transmission is processed, the data can be divided into a plurality of split (or partitioned) files (SFs) and the split files are transmitted by different sessions respectively. Note that in the multiple-session transmission of the disclosure, every split file is regarded as a transmission unit and is transmitted by a single session. Therefore, the multiple-session transmission may be realized, based on the File Transfer Protocol (FTP), HyperText Transfer Protocol (HTTP) and other transmission protocols. In the embodiment of FIG. 1 of the disclosure, the file transmission system 100 includes a transmitting device 110 and a receiving device 120.

In an embodiment of the disclosure, the transmitting device 110 may be a server or a mobile communication device, such as a cell phone, a smartphone, a data card, a notebook, a hotspot, a Universal Serial Bus (USB), a modem, a Tablet PC, or another device. As shown in FIG. 1, the transmitting device 110 includes senders 111-1˜111-3, a first controller 112 and an encoder 113. Note that, the transmitting device 110 shown in FIG. 1 is for the purpose of simplicity and clarity and the disclosure should not be limited to what is shown in FIG. 1.

In an embodiment of the disclosure, the receiving device 120 may be a server or a mobile communication device, such as a cell phone, a smartphone, a data card, a notebook, a hotspot, a Universal Serial Bus (USB), a modem, a Tablet PC or other device. As shown in FIG. 1, the receiving device 120 includes receivers 121-1˜121-3, a second controller 122 and a decoder 123. Note that receiving device 120 shown in FIG. 1 is for the purpose of simplicity and clarity and the disclosure should not be limited to what is shown in FIG. 1.

In an embodiment of the disclosure, the multiple-session transmission is in a push-based network environment. That is to say the sending side can provide data directly for the receiving side. In the push network environment, the transmitting device 110 can determine the receiving device 120 of which data needs to be received directly by the multiple-session transmission. In another embodiment of the disclosure, the multiple-session transmission is in a pull-based network environment. That is to say the sending side transmits data according to the request of the receiving side. In the pull network environment, the transmitting device 110 can transmit data to the receiving device 120 by the multiple-session transmission according to the request of the receiving device 120. In another embodiment of the disclosure, the multiple-session transmission is in a multiple-network environment (can be applied in a push-based or pull-based environment). That is to say the sending side includes more transmitting devices which support different network interfaces (such as 4G, 3G, Wi-Fi, WiMAX and so on). Therefore, the receiving device 120 can receive data from different network interfaces at the same time.

In an embodiment of the disclosure, the senders 111-1˜111-3 are configured to different respective sessions and the receivers 121-1˜121-3 are also configured to different respective sessions. In another embodiment of the disclosure, the disclosure also can apply different number of senders and receivers according to the number of the sessions, and the disclosure should not be limited to what is shown in FIG. 1.

In an embodiment of the disclosure, the encoder 113 is an Application Layer-Forward Error Correction (AL-FEC) encoder, and the decoder 123 is an Application Layer-Forward Error Correction (AL-FEC) decoder. The AL-FEC technology includes rateless AL-FEC (e.g. Raptor, Raptor Q, and LDPC code), compact AL-FEC, fixed rate AL-FEC (e.g., Chinese Remainder Theorem AL-FEC) and so on. The Forward Error Correction (FEC) technology is an encoding technology which can provide reliable data transmission without data re-transmission. AL-FEC technology is usually meant the FEC encoding technology defined in the Internet Engineering Task Force (IETF). The steps of the AL-FEC technology are as follows. First, an AL-FEC encoder encodes a source block which includes K source symbols to make original K source symbols and additional repair symbols. Then, the AL-FEC decoder can recover the source block by K(1+ε) out of the source symbols and repair symbols (E is smaller than 5%). The disclosure adopts the rateless AL-FEC, but the disclosure is not limited thereto. In the compact AL-FEC, repair files are just the split files which the receiving device 120 has not received.

The transmitting device 110 is configured to transmit the transmission data D1 to the receiving device 120 by the multiple-session transmission. When the transmitting device 110 transmits the transmission data D1, the transmitting device 110 separates the transmission data D1 into split files (e.g. SF1˜SF8) and transmits the split files by the senders 111-1˜111-3. The transmission data D1 is regarded as streaming data, video data, audio data, or image data. The disclosure adopts the streaming data, but the disclosure is not limited thereto. When a repair-file mechanism is triggered, the first controller 112 of the transmitting device 110 would generate a repair file according to the split files which the receiving device 120 has not received. The receiving device 120 receives a plurality of the split files and the repair file by the receivers 121-1˜121-3. When the repair-file mechanism is triggered, the receiving device 120 recovers the split files which the receiving device 120 has not received by the second controller 122 according to the repair file. Detailed description of the repair-file mechanism will be discussed below.

In an embodiment of the disclosure, the repair-file mechanism is a group-based mechanism, a threshold-based mechanism or a timer-based mechanism. In the group-based mechanism, all the split files included in the data would be divided into 1 group with N split files each, and only when one group has been transmitted successfully, the next group would be transmitted. For example, if one group includes 8 split files, only when the first 8 split files have been transmitted, the next 8 split files would be transmitted. In the group-based mechanism, when a group of split files is being transmitted, a session (sender) has been in an idle mode and there is no other fresh split file of the group that is never assigned to a session for transmission, and certain split files in the other sessions have not been completely transmitted, the repair-file mechanism would be triggered to accelerate the transmission of the split files. In the threshold-based mechanism, the sender sets a delay threshold of the split files, such as 5. When an idle session desires to transmit the next split file and the delay order of the next split file is bigger than the delay threshold, the repair-file mechanism would be triggered. For example, if the delay threshold is 5, when an idle session desires to transmit the split file SF8, and the split file SF2 has not been transmitted successfully (the delay order is 6 (8-2) bigger than 5), the repair-file mechanism would be triggered. In the timer-based mechanism, every sender is configured with a timer for each split file, such as for 25 seconds. When the split file has not been transmitted after the timer ends, the repair-file mechanism would be triggered. The disclosure adopts the group-based mechanism, but the disclosure should not be limited thereto.

Referring to FIG. 1, the split files SF1-SF8 are in the same group. When the receiving device 120 has received the split files SF3-SF8. There are no other split files that can be transmitted by the sender 111-3 and the senders 111-1 and 111-2 are still transmitting the split files SF1 and SF2. The first controller 112 would trigger the repair-file mechanism and generate the repair file according to the split files SF1 and SF2 which the receiving device 120 has not received, and then transmit the repair file by the idle sender 111-3. When the receiving device 120 has received and recovered the split files SF1-SF8, the first controller 112 would stop the repair-file mechanism and process to transmit the next group of the split files until all split files are transmitted successfully. In the disclosure, one repair file is generated, but the disclosure should not be limited thereto. In different embodiments, the first controller 112 also can generate a plurality of different repair files. In addition, there may be a plurality of senders in idle mode, and the disclosure should not be limited to FIG. 1. In another embodiment of the disclosure, the repair-file mechanism is triggered by the second controller 122.

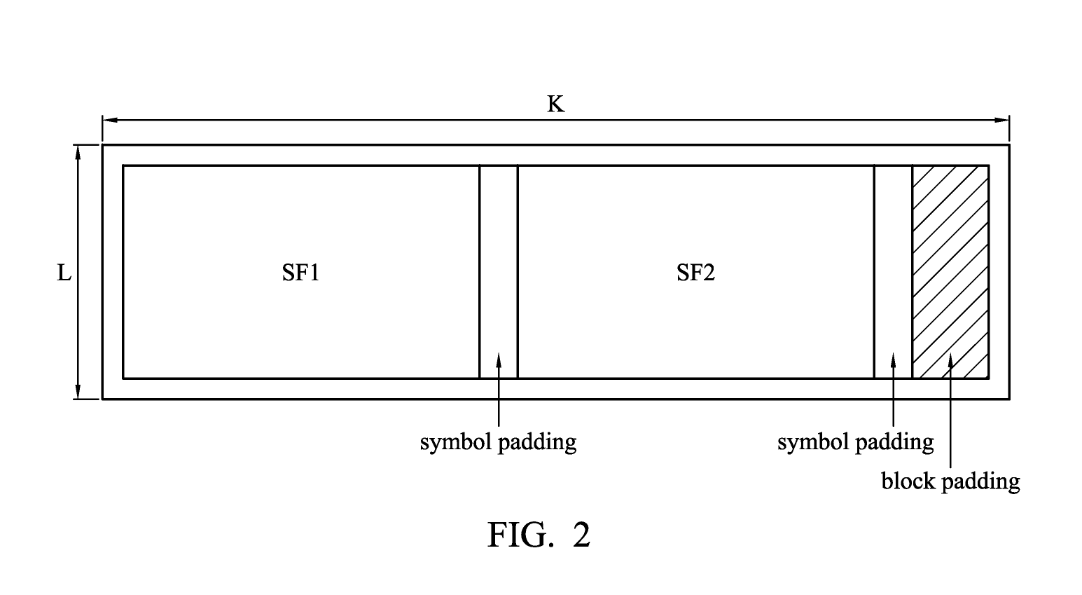

FIG. 2 is a schematic diagram illustrating the source block according to an embodiment of the disclosure. In the process of generating the repair file, first, the first controller 112 determines the coding parameters and then transforms the split files SF1 and SF2 which the receiving device 120 has not received into a source block according to the coding parameters. As shown in FIG. 2, the source block includes the split files SF1 and SF2 and the symbols, and the symbols are generated by the symbol-padding and block-padding process. After padding process, the source block includes K symbols, and the size of the each symbol is L bits. In addition, the first controller 112 stores and records the FEC parameters (K and L) and the file information of the split files SF1 and SF2, such as file name, file number, file size, Encoding Symbol Identification (ESI) and so on, into a File Symbol Table (FST). The first controller 112 determines the FEC parameters by a FST algorithm. In an embodiment of the disclosure, the FST algorithm adopts a fixed-K method, as follows:

Input: K, and the split files SF₁, . . . , SFₙ which are
needed to accelerate their transmission
Output: File Symbol Table (FST)
algorithm:
1. calculating the smallest symbol size L′ = ceil((Σⁿᵢ₌₁|SFᵢ|)/K), wherein
|SFᵢ| denotes the real size of the SFᵢ and the unit of |SFᵢ| is bit
2. calculating the real source block size K′ after the symbol-padding
process according to the symbol size L′. If K′ > K, set L′ = L′ + 1 and
re-calculate K′, until K′ ≦ K and set final resulted L = L′
3. processing the block-padding process to make K′ = K, and recording
the files and the FST which are generated according to K and L

In another embodiment of the disclosure, the FST algorithm adopts a fixed-L method, as follows:

Input: L, and the split files SF₁, . . . , SFₙ which are
needed to accelerate their transmission
Output: File Symbol Table (FST)
algorithm:
1. transforming each of the SFᵢ into source symbols of the source block by
symbol-padding process according to L
2. calculating K = Σⁿᵢ₌₁ |S Fᵢ| and recording the files and the FST which
generated according to K and L

After the source block has been generated, the encoder 113 encodes the source block to a plurality of repair symbols. Then, the first controller 112 generates the repair file according to the repair symbols and the Encoding Symbol Identification (ESI) of the first repair symbol. The first controller 112 transmits the repair file and the File Symbol Table (FST) to the receiving device 120 by the sender 111-3. The receiving device 120 recovers the repair file to repair symbols and the ESIs of the repair symbols according to the ESI of the first repair symbol and the information of the FST. In an embodiment of the disclosure, the size of the repair file is determined according to a repair-file algorithm. The repair-file algorithm can adopt a maximum case policy, an average case policy, or a minimum case policy. The repair-file algorithm which adopts a maximum case policy is shown as below:

Step1. arranging the s split files which need the accelerated transmission from the
smallest to the biggest according to the sizes of these split files (the number of the symbols
after the symbol-padding process), such as SF₁, SF₂, . . . SFs, wherein ||SFᵢ|| <
||SFᵢ₊₁ ||, ||SFᵢ|| denotes the number of the source symbols of the SF₁ after the
symbol-padding process.
Step 2. The size of the first repair file RF₁ is ||RF₁|| = ((K)(1 + ε) - the number of
the symbols generated by the block-padding process - (||SF₁|| + ||SF₂|| + . . . ||SFₛ₋₁||)),
in this case, this is supposing that the biggest split file is received last.
Step 3. The size of the next repair file RFᵢ is ||RFᵢ|| = K (1 + ε) - the number of
the symbols generated by the block-padding process- (the number of the symbols of the r
files which have been received) - (the number of the symbols of the minimal (s-r-1)
repair files and split files which have not been completely transmitted), which enables the s
split files to be completely recovered upon receiving any s-r of split files and repair files
which have not been completely transmitted. Namely, the total number of received symbols
is to be equal to or greater than (K (1 + ε) - the number of the symbols generated by the
block-padding process).
Step4. When the number of the symbols of the received files is greater than
(K(1 + ε) - the number of the symbols generated by block-padding process) or the split files
SF1~SFs have been received, stopping the flow. Otherwise, the method returns to Step 3.

The repair-file algorithm which adopts an average case policy is shown as follows:

Step 1. arranging the s split files which need the accelerated transmission from the
smallest to the biggest according the sizes of these split files (the number of the symbols
after the symbol-padding process), such as SF₁, SF₂, . . . SFs, wherein ||SFᵢ|| <
||SFᵢ₊₁||, ||SFᵢ|| denotes the number of the symbols after the symbol-padding process.
Step 2. The size of the first repair file is (K(1 + ε) - the number of the symbols
generated by the block-padding process)/s.
Step 3. The size of the next repair file RFᵢ is ||RFᵢ|| = (K(1 + ε) - the number of
the symbols generated by block-padding process - (the number of symbols of the r received
files))/s-r. When s-1 files have been received, the size of the repair file RFᵢ of Step 3 is
K(1 + ε) - the number of the symbols generated by block-padding process - (the number of
symbols of the s-1 received files).

The repair-file algorithm which adopts a minimum case policy is shown as follows:

Step 1. arranging the s split files which need the accelerated transmission from the
smallest to the biggest according to the sizes of these split files (the number of the symbols
after the symbol-padding process), SF₁, SF₂, . . . SFs, wherein ||SFᵢ|| < ||SFᵢ₊₁||,
||SFᵢ|| denotes the number of symbols after the symbol-padding process
Step 2. The size of the first repair file is (K(1 + ε) - the number of symbols
generated by the block-padding process- (||SF₂|| + ||SF₃|| + . . . ||SFₛ||)). In this case, this is
supposing that the smallest split file is received last.
Step 3. The size of the next repair file RFᵢ is ||RFᵢ|| = K (1 + ε) - the number of
the symbols generated by the block-padding process- (the number of the symbols of the r
files which have been received) - (the number of the symbols of the maximal (s-r-1)
repair files and split files which have not been completely transmitted). If ||RFᵢ|| <=
0, ||RFᵢ || is set to the minimal number of the symbols of the repair files and the split files
which are currently transmitted. When s-1 files have been received, the size of the repair
file RFᵢ of Step 3 is K(1 + ε) - the number of the symbols generated by block-padding
process- (the number of symbols of the s-1 received files).

When the receiving device 120 receives any s files from the repair files and the un-received s SFs, the decoder 123 recovers the source block from the received files. The receiving device 120 then recovers all the un-received SFs according to the information of the FST. For example, in FIG. 1, there are two un-received split files (SF1 and SF 2), therefore the decoder 123 needs to receive any two files from split files (SF1 and SF 2) and the repair files. Then, the second controller 122 recovers the two un-received split files (SF1 and SF 2) according to the information of the FST. Giving another example, if there are 3 split files which have not been received by the receiving device 120 and the first controller 112 generates 3 repair files. The decoder 123 needs to receive any 3 files from the 6 files (3 split files and 3 repair files). The second controller 122 recovers the three un-received split files according to the information of the FST. The original source block is recovered after the decoder 123 decodes the enough received files.

When the decoder 123 has decoded the received files to the source block according the information of the FST, the second controller 122 would recover the source block to the un-received split files.

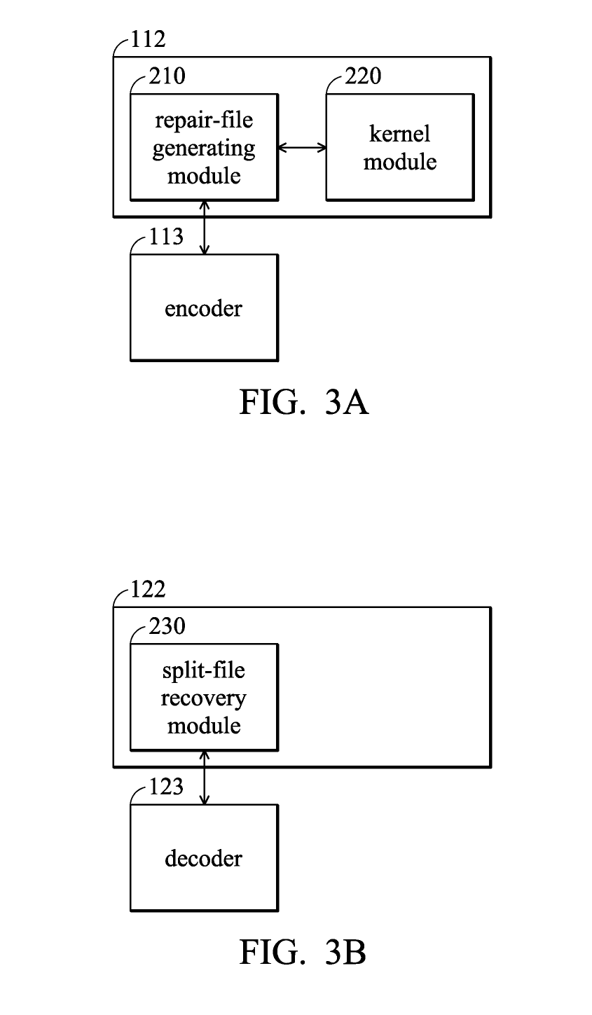

FIG. 3A is a schematic diagram illustrating the first controller 112 according to an embodiment of the disclosure. As shown in FIG. 3A, when the repair-file mechanism is triggered by the first controller 112, the first controller 112 includes a repair-file generating module 210 and a kernel module 220. The repair-file generating module 210 is configured to generate repair files. The kernel module 220 is configured to trigger/stop the repair-file mechanism and determine when the repair-file mechanism should be triggered/stopped. FIG. 3B is a schematic diagram illustrating the second controller 122 according to the embodiment of the disclosure. As shown in FIG. 3B, the second controller 122 includes a split-file recovery module 230. The split-file recovery module 230 is configured to generate the un-received split files according to the repair file. In the embodiment, the first controller 112 and the second controller 122 include a first controlling module (not presented) and a second controlling module (not presented) respectively. The first controlling module and the second controlling module can coordinate the works of the repair-file generating module 210, kernel module 220 and split-file recovery module 230. In the embodiment, the repair-file mechanism is triggered by the first controller 112. Namely, the repair-file mechanism is triggered in a sending side, therefore the embodiment is applied in a push-based network environment and the sending side can provide data to the receiving side.

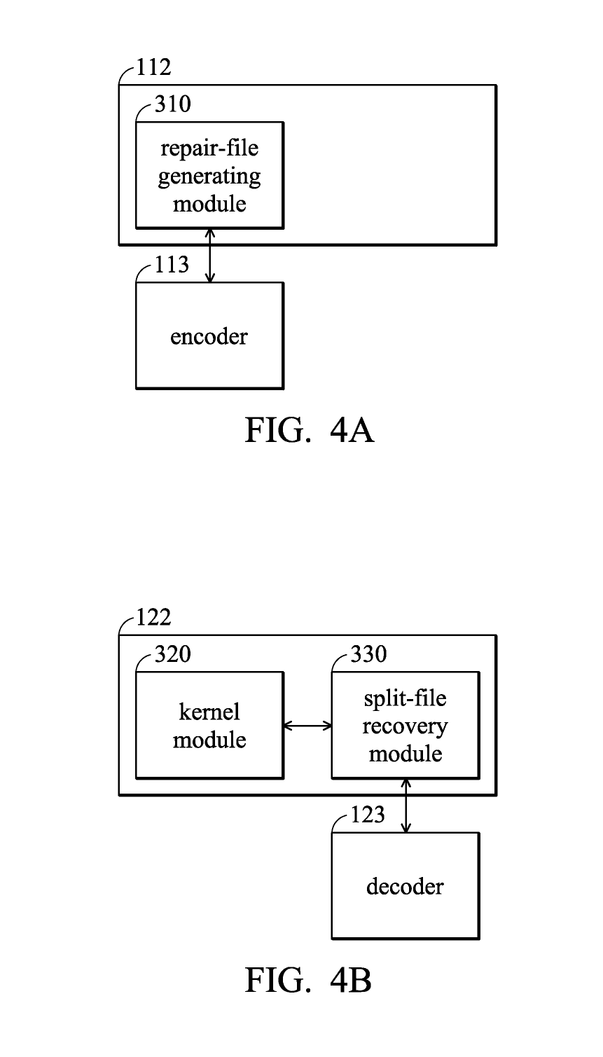

FIG. 4A is a schematic diagram illustrating the first controller 112 according to another embodiment of the disclosure. As shown in FIG. 4A, when the repair-file mechanism is triggered by the second controller 122, the first controller 112 includes a repair-file generating module 310. The repair-file generating module 310 is configured to generate repair files. FIG. 4B is a schematic diagram illustrating the second controller 122 according to the embodiment of the disclosure. As shown in FIG. 4B, the second controller includes a kernel module 320 and a split-file recovery module 330. The kernel module 320 is configured to trigger/stop the repair-file mechanism and determine when the repair-file mechanism should be triggered/stopped. The split-file recovery module 330 is configured to generate the un-received split files according to the repair file. In the embodiment, the first controller 112 and the second controller 122 include a first controlling module (not presented) and a second controlling module (not presented) respectively. The first controlling module and the second controlling module can coordinate the works of the repair-file generating module 310, kernel module 320 and split-file recovery module 330. In the embodiment the repair-file mechanism is triggered by the second controller 122. Namely, the repair-file mechanism is triggered in a receiving side, therefore the embodiment is applied in a pull-based network environment and the sending side should transmit data according to the request of the receiving side.

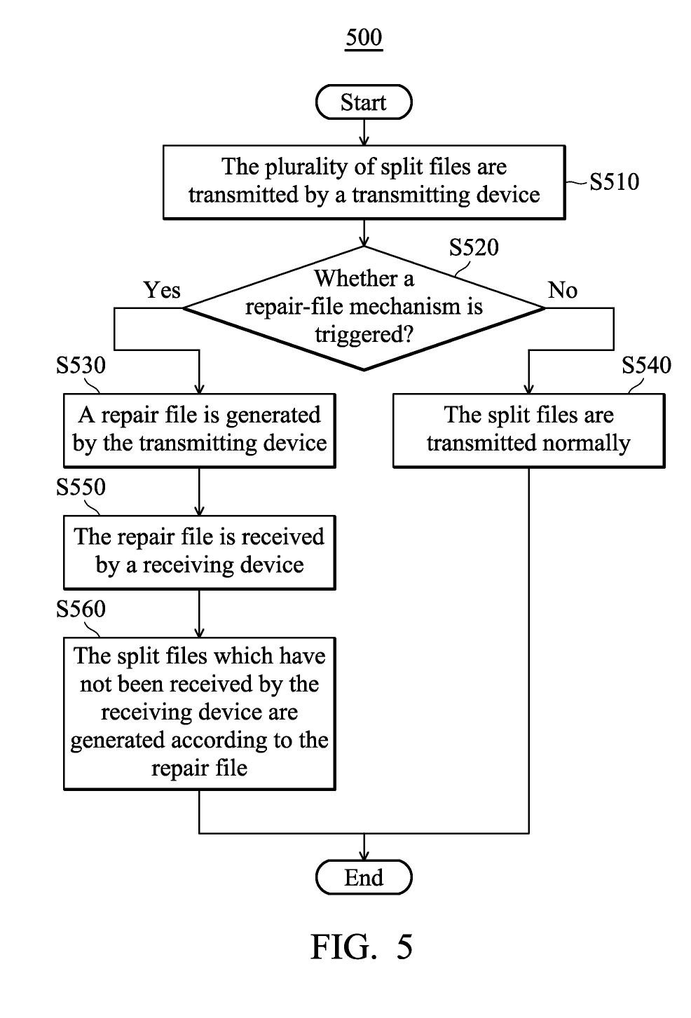

FIG. 5 is a flowchart of a method for transmitting files according to an embodiment of the disclosure. In the embodiment, the method is applied for transmitting data in a multiple-session transmission by a transmitting device and a receiving device, wherein the data includes a plurality of split files, and in the multiple-session transmission, every split file is regarded as a transmission unit. As shown in FIG. 5, first, in step S510, the plurality of split files are transmitted by a transmitting device. In step S520, it is determined whether a repair-file mechanism is triggered. When the repair-file mechanism is triggered, step S530 is executed. In step S530, a repair file is generated by the transmitting device. When the repair-file mechanism is not triggered, step S540 is executed. In step S540, the split files are transmitted normally. In step S550, the repair file is received by the receiving device. In step S560, the split files which have not been received by the receiving device are generated according to the repair file.

In the embodiment, the repair-file mechanism is a group-based mechanism, a threshold-based mechanism or a timer-based mechanism. In the group-based mechanism, all the split files included in the data would be divided into 1 group with N split files each, and only when one group has been transmitted successfully, the next group would be transmitted. When a group of split files have not been completely transmitted, and one or more sessions of the multiple sessions have been in an idle mode, the repair-file mechanism would be triggered. When the group of split files has been completely transmitted/recovered, the repair-file mechanism would be stopped and the next group would be transmitted.

In the embodiment, the repair-file mechanism can be triggered by the receiving device or transmitting device. In Step S530 further includes that the transmitting device transforms the split files (which have not been received by the receiving device) into a source block according to coding parameters and stores the coding parameters and file information in a File Symbol Table (FST), wherein the coding parameters include the source block size K and the symbol size L. In Step S530 further includes that a plurality of repair symbols are generated according to the source block by an encoder of the transmitting device. Then, the transmitting device generates the repair file according to the repair symbols, and the repair file and the FST are transmitted to the receiving device by the transmitting device. The encoder of the transmitting device may be an AL-FEC encoder.

In steps S550 and S560 further include that when the total numbers of the files which the receiving device has received from the repair files and the previously un-received split files are equal to the numbers of the previously un-received split files, the source block is generated according to the FST by a decoder of the receiving device, and the receiving device recovers the source block to the previously un-received split files. The decoder of the receiving device may be an AL-FEC decoder.

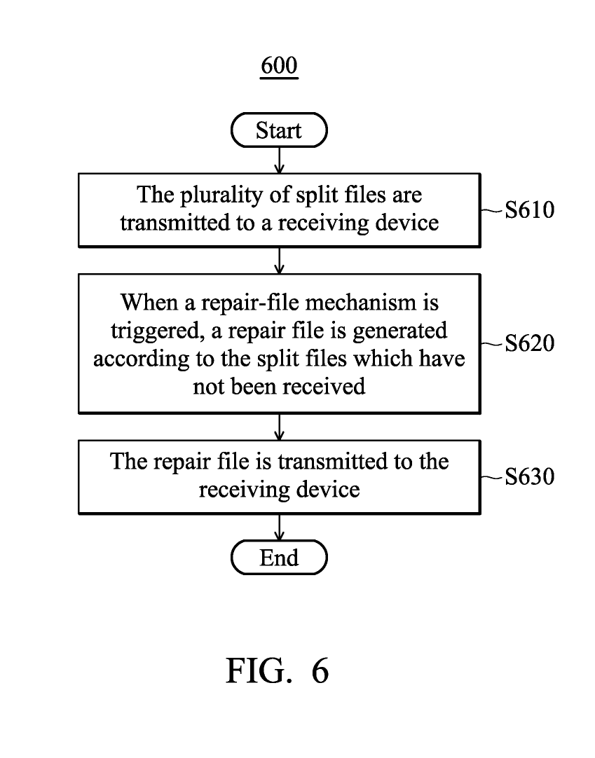

FIG. 6 is a flowchart of a method for transmitting files according to another embodiment of the disclosure. In the embodiment, the method is applied for transmitting data in a multiple-session transmission by a transmitting device, wherein the data includes a plurality of split files and in the multiple-session transmission, every split file is regarded as a transmission unit. As shown in FIG. 6, first, in step S610, the plurality of split files are transmitted to a receiving device. In step S620, when a repair-file mechanism is triggered, a repair file is generated according to the un-received split files. In step S630, the repair file is transmitted to the receiving device. In the embodiment, the repair-file mechanism is triggered by the transmitting device or the receiving device.

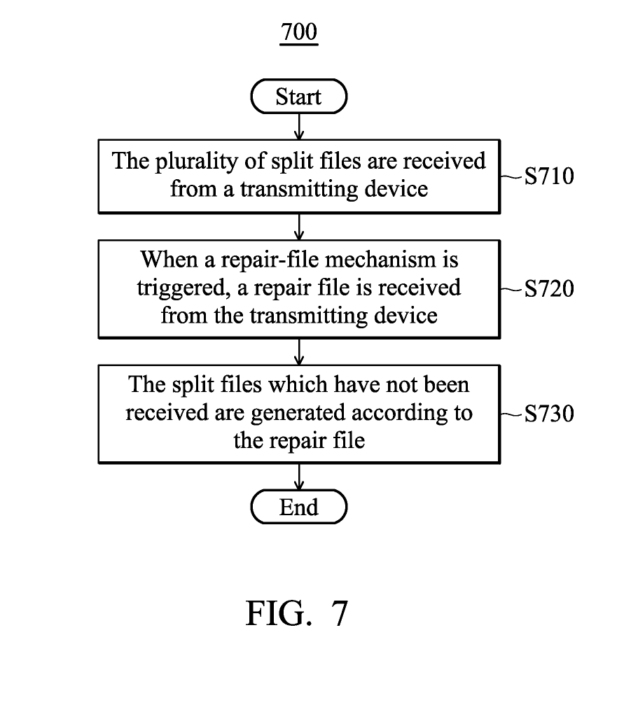

FIG. 7 is a flowchart of a method for transmitting files according to another embodiment of the disclosure. In the embodiment, the method is applied for transmitting data in a multiple-session transmission by a receiving device, wherein the data includes a plurality of split files and in the multiple-session transmission, every split file is regarded as a transmission unit. As shown in FIG. 7, first, in step S710, the plurality of split files are received from a transmitting device. In step S720, when a repair-file mechanism is triggered, a repair file is received from the transmitting device. Then in step S730, the un-received split files are recovered according to the repair file.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in user equipment. Alternatively, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

Reference throughout this specification to “one embodiment” or “an embodiment” means that a particular feature, structure, or characteristic described in connection with the embodiment is included in at least one embodiment of the invention, but does not denote that they are present in every embodiment. Thus, the appearances of the phrases “in one embodiment” or “in an embodiment” in various places throughout this specification are not necessarily referring to the same embodiment of the invention. Furthermore, the particular features, structures, or characteristics may be combined in any suitable manner in one or more embodiments. Furthermore, the figures. of the disclosure are only for illustration and are not drawn to scale.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents. In addition, reference numbers may be repeated throughout the embodiments, but they do not require that feature(s) of one embodiment apply to another embodiment, even if they share the same reference number.

What is claimed is:

1. A system for transmitting files, which is applied for transmitting data in a multiple-session transmission, wherein the data includes a plurality of split files and in the multiple-session transmission, every split file is regarded as a transmission unit including:
a transmitting device transmitting the plurality of split files, when a repair-file mechanism is triggered, generating a repair file, and
a receiving device receiving the repair file and generating the split files which have not been received according to the repair file.

2. The system of claim 1, wherein the transmitting device further includes:
a plurality of senders transmitting at least one of the split files and the repair file to the receiving device;
an encoder; and
a first controller generating the repair file according to the split files which have not been received by the receiving device.

3. The system of claim 2, wherein the receiving device further includes:
a plurality of receivers receiving at least one of the split files and the repair file;
a decoder; and
a second controller generating the split files which have not been received according to the repair file.

4. The system of claim 3, wherein the first controller transforms the split files which have not been received into a source block according to coding parameters, and stores the coding parameters and file information in a File Symbol Table (FST).

5. The system of claim 4, wherein the encoder generates a plurality of repair symbols according to the source block and the first controller generates the repair file according to the repair symbols and transmits the repair file and the File Symbol Table to the receiving device by the senders.

6. The system of claim 4, wherein when the receiving device receives a number of files from the repair file and the split files which have not been received and the number of files is equal to the number of the split files which have not been received, the decoder generates the source block according to the File Symbol Table, and the second controller recovers the source block to the split files which have not been received.

7. The system of claim 1, wherein the repair-file mechanism includes a group-based mechanism, a threshold-based mechanism or a timer-based mechanism.

8. The system of claim 3, wherein the repair-file mechanism is triggered by the first controller or the second controller.

9. The system of claim 1, wherein a size of the repair file is determined by a repair-file algorithm.

10. A transmitting device, which is applied for transmitting data in a multiple-session transmission, wherein the data includes a plurality of split files and in the multiple-session transmission, every split file is regarded as a transmission unit, including:
a plurality of senders transmitting the plurality of split files and a repair file to a receiving device;
an encoder; and
a first controller generating the repair file according to the split files which have not been received by the receiving device when a repair-file mechanism is triggered.

11. The transmitting device of claim 10, wherein the first controller transforms the split files which have not been received into a source block according to coding parameters, and stores the coding parameters and file information in a File Symbol Table (FST).

12. The transmitting device of claim 11, wherein the encoder generates a plurality of repair symbols according to the source block and the first controller generates the repair file according to the repair symbols and transmits the repair file and the File Symbol Table to the receiving device by the senders.

13. The transmitting device of claim 10, wherein when the repair-file mechanism is triggered by the first controller, the first controller includes:
a repair-file generating module generating the repair file; and
a kernel module triggering the repair-file mechanism.

14. The transmitting device of claim 10, wherein when the repair-file mechanism is triggered by the receiving device, the first controller includes:
a repair-file generating module generating the repair file.

15. A receiving device, which is applied for receiving data in a multiple-session transmission, wherein the data includes a plurality of split files and in the multiple-session transmission, every split file is regarded as a transmission unit, including:
a plurality of receivers receiving at least one of the split files and repair file from a transmitting device;
a decoder; and
a second controller generating the split files which have not been received according to the repair file when a repair-file mechanism is triggered.

16. The receiving device of claim 15, wherein when the receiving device receives a number of files from the repair file and the split files which have not been received and the number of files is equal to the number of the split files which have not been received, the decoder generates a source block according to a File Symbol Table, and the second controller recovers the source block to the split files which have not been received.

17. The receiving device of claim 15, wherein when the repair-file mechanism is triggered by the second controller, the second controller includes:
a split-file recovery module generating the split files which have not been received by the receiving device; and
a kernel module triggering the repair-file mechanism and demand the transmitting device to generate the repair file.

18. The receiving device of claim 15, wherein when the repair-file mechanism is triggered by the transmitting device, the second controller includes:
a split-file recovery module generating the split files which have not been received by the receiving device.

19. A method for transmitting files, which is applied for transmitting data in a multiple-session transmission, wherein the data includes a plurality of split files and in the multiple-session transmission, every split file is regarded as a transmission unit, including:
transmitting the split files by a transmitting device
generating a repair file when a repair-file mechanism is triggered;
receiving the repair file by a receiving device; and
generating the split files which have not been received according to the repair file.

20. The method of claim 19, wherein the repair-file mechanism is triggered by the receiving device or the transmitting device.

21. The method of claim 19, further including:
transforming the split files which have not been received into a source block according to coding parameters by the transmitting device; and
storing the coding parameters and file information in a File Symbol Table (FST).

22. The method of claim 21, further including:
generating a plurality of repair symbols according to the source block by a encoder of the transmitting device;
generating the repair file according to the repair symbols by the transmitting device; and
transmitting the repair file and the File Symbol Table to the receiving device by the transmitting device.

23. The method of claim 22, further including:
generating the source block according to the File Symbol Table by a decoder of the receiving device when the receiving device receives a number of files from the repair file and the split files which have not been received and the number of files is equal to the number of the split files which have not been received; and
recovering the source block to the split files which have not been received by the receiving device.

24. A method for transmitting files, which is applied for transmitting data in a multiple-session transmission by a transmitting device, wherein the data includes a plurality of split files and in the multiple-session transmission, every split file is regarded as a transmission unit, including:
transmitting the split files to a receiving device;
generating a repair file according to the split files which have not been received by the receiving device when a repair-file mechanism is triggered; and
transmitting the repair file to the receiving device.

25. The method of claim 24, further including:
transforming the split files which have not been received into a source block according to coding parameters; and
storing the coding parameters and file information in a File Symbol Table (FST).

26. The method of claim 25, further including:
generating a plurality of repair symbols according to the source block by a encoder;
generating the repair file according to the repair symbols; and
transmitting the repair file and the File Symbol Table to the receiving device.

27. A method for transmitting files, which is applied for receiving data in a multiple-session transmission by a receiving device, wherein the data includes a plurality of split files and in the multiple-session transmission, every split file is regarded as a transmission unit, including:
receiving at least one of the split files and repair file from a transmitting device;
receiving a repair file when a repair-file mechanism is triggered; and
generating the split files which have not been received according to the repair file.

28. The method of claim 27, further including:
generating a source block according to a File Symbol Table by a decoder when receiving a number of files from the repair file and the split files which have not been received and the number of files is equal to the number of the split files which have not been received; and
recovering the source block to the split files which have not been received.
